(19) United States
(12) Patent Application Publication
(10) Pub. No.: US 2025/0291086 A1
(43) Pub. Date: Sep. 18, 2025

(54) SYSTEMS AND METHODS FOR WELL PROPERTY GENERATION USING PRESSURE, VOLUME, AND TEMPERATURE DATA DERIVED FROM MULTIPLE SOURCES AND TIMES

(71) Applicants: ARAMCO SERVICES COMPANY, Houston, TX (US); SAUDI ARABIAN OIL COMPANY, Dhahran (SA)

(72) Inventors: Weichang Li, Katy, TX (US); Yuchen Jin, Houston, TX (US); Hana Matouq, Dhahran (SA); Tao Lin, Katy, TX (US)

(73) Assignees: ARAMCO SERVICES COMPANY, Houston, TX (US); SAUDI ARABIAN OIL COMPANY, Dhahran (SA)

(21) Appl. No.: 18/602,712

(22) Filed: Mar. 12, 2024

(51) Int. Cl. G01V 11/00; G06V 30/164; G06V 30/416

(52) U.S. Cl. CPC G01V 11/002; G06V 30/164; G06V 30/416

(57) ABSTRACT

Various systems and methods are discussed for characterizing well properties. As one of many non-limiting examples, a well property system is discussed that includes a sensor set, a logging system, an archive conversion system, and a well property prediction system. Each of the aforementioned components and systems may be configured to sense and/or operate on pressure, volume, and temperature data from at least one location at a well site.

### BACKGROUND

A variety of parameters are monitored in oil and gas production wells. For example, pressure, volume, and temperature may be periodically monitored, and this information may be included in a report. It is common for a large oil and gas production company to accumulate hundreds of thousands of such reports extending over years of their operation. The value of these reports is limited as there are too many for proper consideration. In some cases, only a small number of the reports are ever meaningfully used. Because of this, critical information about a given well or field is left unused.

Accordingly, there exists a need for systems and methods for using historical information for predicting a well property.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some embodiments provide methods for automated well property prediction based upon a plurality of individual well reports. Such methods may include: obtaining, by a processing resource, a plurality of well reports, wherein each of the plurality of well reports include pressure, volume, and temperature (PVT) data for a respective well at a respective time; automatically extracting, by the processing resource, PVT data from the plurality of well reports; automatically incorporating, by the processing resource, the extracted PVT data corresponding to the respective well into a plurality of tables for the respective well; automatically merging, by the processing resource, the plurality of tables into a PVT property profile for the respective well stored in a database, wherein the respective well is one of a plurality of wells, and wherein the database includes a respective PVT property profile for each of the plurality of wells; selecting a PVT property profile for a selected well from the database; and applying, by the processing resource, PVT data analysis to the PVT property profile for the selected well to yield a PVT property prediction.

Other embodiments provide systems for well property prediction based upon a plurality of individual well reports. The systems may include: a sensor set, a logging system, an archive conversion system, and a well property prediction system. The sensor set may be configured to sense pressure, volume, and temperature (PVT) data from at least one location at a well site. The logging system may be configured to: receive the PVT data; merge the PVT data into a PVT property profile stored in a database, where the PVT property profile corresponds to a well at the well site, the well is one of a plurality of wells, and the database includes a respective PVT property profile for each of the plurality of wells. The archive conversion system may be configured to: obtain a plurality of well reports for the well, wherein each of the plurality of well reports include PVT data for the well at a respective time; extract PVT data from the plurality of well reports; incorporate the extracted PVT data corresponding to the well into a plurality of tables for the well; and merge the plurality of tables into the PVT property profile for the well stored in the database. The well property prediction system may be configured to: select a PVT property profile for a selected well from the database, and apply PVT data analysis to the PVT property profile for the selected well to yield a PVT property prediction.

Other aspects and/or advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIG. 1 depicts a hydrocarbon producing well including sensor sets and processing systems that may be used in accordance with various embodiments.

FIGS. 2A-2C is a flow diagram showing a method in accordance with some embodiments for well property generation using pressure, volume, and temperature data derived from multiple sources and at different times.

FIG. 3 is a flow diagram showing a method for converting a well report accessed from a historical archive to a defined electronic format in accordance with one or more embodiments.

FIG. 4 is a flow diagram showing a method for converting a well report in one electronic format and accessed from the historical archive to the defined electronic format in accordance with one or more embodiments.

FIG. 5 is a block diagram depicting an example workflow in accordance with some embodiments.

FIG. 6 is a block diagram showing functions of the parsing and extraction engine processes of the workflow of FIG. 5 in accordance with various embodiments.

FIG. 7 is a flow diagram showing a method for automated well property prediction based upon a plurality of individual well reports in accordance with some embodiments.

FIG. 8 illustrates computational functionalities associated with the method for digitizing PVT reports, in accordance with one or more embodiments of the disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

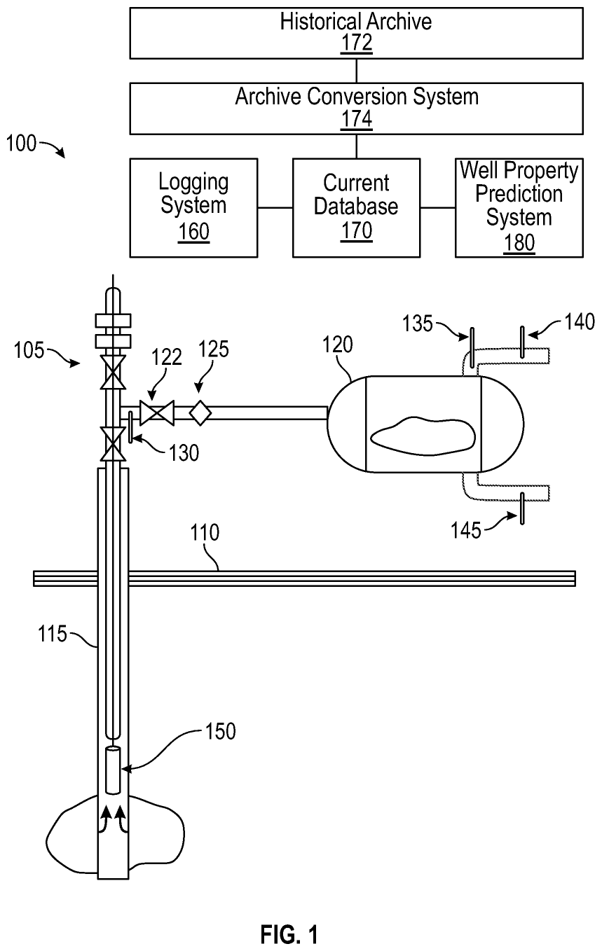

In the following description of FIGS. 1-8, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a wellbore” includes reference to one or more of such wellbores.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used herein, the phrase “processing resource” is used in its broadest sense to mean any electronic circuit capable of executing instructions. Thus, a processing resource may be a single computer processor, multiple computer processors implemented in a single system, multiple computer processors implemented across multiple systems. Based upon the disclosure provided herein, one of ordinary skill in the art will recognize a variety of processing resources that may be used in relation to different embodiments.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Pressure, volume and temperature (PVT) tests are used in the hydrocarbon exploration and production process. A PVT analysis helps to determine phase behavior and fluid properties of oil and gas samples from wells, both in the reservoir (i.e., downhole) and at the surface, to discover how hydrocarbons flow from the well and allow operators to determine the most cost-effective methods for extraction.

A PVT analysis provides characterization of specific reservoir's fluid behavior under certain conditions, such as bubble point, the differential as well as the flash liberation process where gas is separated from liquid sample, the reservoir to surface volume relations, oil/gas formation volume factor (i.e., the ratio of oil/gas volume at the reservoir pressure and temperature condition versus those at the surface), and ultimately the composition of the oil/gas extracted from the wells. The PVT analysis provides information on the value and volume of crude oil and gas in the reservoir, the potential strategy to optimize the liquid recovery process, the unique flow properties of this reservoir and how to maintain the pressure during production, and the profitability of an identified play.

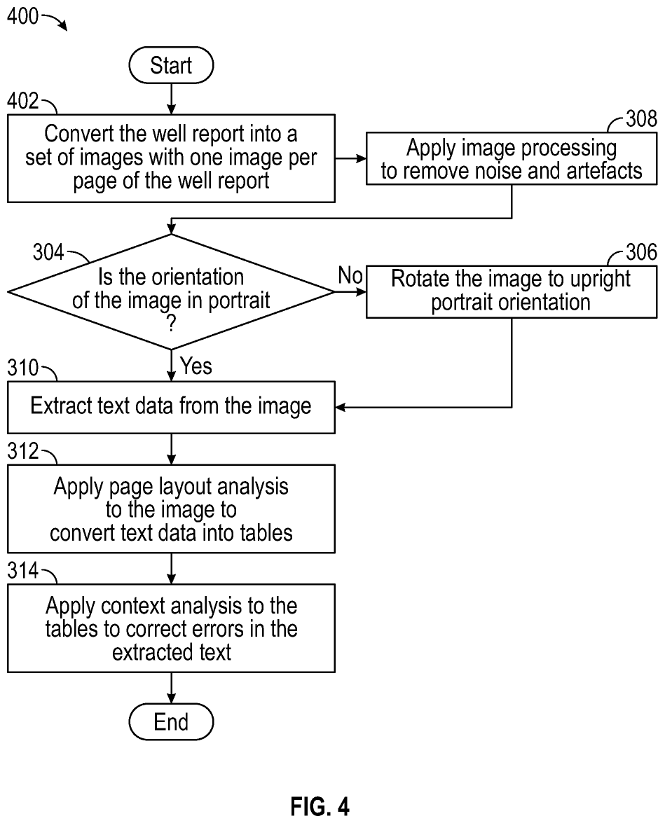

Some embodiments discussed herein incorporate workflow-based parallelism to accelerate the tasks performed as part of the workflow. The same architecture may be used with both multithreading and multiprocessing. Various embodiments provide reports which, if workflow-based parallelism is ignored, the processing of such reports may be divided into the following steps:
1. FileRead, used for scheduling the tasks of page parsing.
2. Preprocessing, including image enhancement and annotations.
3. OCR, including the text information extraction. No tabular data is provided in this step.
4. TableExtraction, including the text correction and the tabular data extraction based on the layout analysis.
   An example of such flow is discussed below in relation to FIG. 4.

In some embodiments, for each kind of task, several workers are allocated. For example, if multiprocessing is used, there may be ten (10) processes waiting for preprocessing tasks and twenty (20) tasks waiting for optical character recognition (OCR) tasks. In this way, different steps can be run simultaneously. Suppose that the first page of the first report has been preprocessed just now. Then, there should be one worker working on OCR of the same page, while the preprocessing worker will be processing the next page now. As just one of many benefits, embodiments provide for splitting of the computation and I/O. For all tasks, saving the results is always scheduled at the end of the task. Before saving the file, the data processed by the current task will be delivered to another task working for the next step. In this way, the I/O and the computation may be allowed to run simultaneously. This provides balance between the processing and the I/O.

Turning to FIG. 1, a hydrocarbon production system 100 is shown in accordance with some embodiments. Hydrocarbon production system 100 includes a well 115 extending from a well head 105 into a formation below a surface 110. Hydrocarbons from within well 115 are delivered via a valve 122 and choke 125 into a separator 120. A number of sensors are used to measure characteristics of hydrocarbon production system 100. Such sensors include, but are not limited to, wellhead sensors 130, isokinetic sampling sensors 135, separator gas sensors 140, separator liquid sensors 145, and downhole sampling tool string sensors 150. Downhole sampling tool string sensors 150 may include, but are not limited to, exothermal sensors, SPS, and/or PDS samplers. Based upon the disclosure provided herein, one of ordinary skill in the art will recognize a variety of sensors that may be used as downhole sampling tool string sensors 150 in relation to different embodiments. Various sensor types may be used for each of wellhead sensors 130, isokinetic sampling sensors 135, separator gas sensors 140, separator liquid sensors 145, and downhole sampling tool string sensors 150. In some embodiments, one of more of wellhead sensors 130, isokinetic sampling sensors 135, separator gas sensors 140, separator liquid sensors 145, and downhole sampling tool string sensors 150 include a pressure sensor, a volume sensor, and a temperature sensor. Based upon the disclosure provided herein, one of ordinary skill in the art will recognize different types of pressure sensors, volume sensors, and/or temperature sensors that may be used in relation to different embodiments.

A logging system 160 receives data from each of wellhead sensors 130, isokinetic sampling sensors 135, separator gas sensors 140, separator liquid sensors 145, and downhole sampling tool string sensors 150. In some embodiments, logging system 160 includes a processing resource, a computer readable medium, and a transceiver. The transceiver is configured to receive data from the various sensors. In some embodiments, the transceiver includes a wireless transceiver, and the data is received via a wireless communication link over which one or more of wellhead sensors 130, isokinetic sampling sensors 135, separator gas sensors 140, separator liquid sensors 145, and downhole sampling tool string sensors 150 transfer their measurement data. In other embodiments, the transceiver includes a wired transceiver that is wired to one or more of wellhead sensors 130, isokinetic sampling sensors 135, separator gas sensors 140, separator liquid sensors 145, and downhole sampling tool string sensors 150. The computer readable medium includes instructions executable by the processing resource to: receive the data from the sensors, incorporate the data into a defined report format to yield a well report, and store the well report to a current database 170. Well reports are produced in the defined well report format to summarize the results from PVT test and analysis, consisting of a series of tables containing information about the well/reservoir name and information such as reservoir temperature and pressure, the sampling information, the composition in terms of mole percent, the PVT properties (e.g., the bubble point, the liquid phase compressibility, the relative volume, the separator tests and flashed gas analysis, the liquid phase viscosity, and the mixture density). The PVT properties are measured at different pressure ranges. In some embodiments, the defined well report format includes a date and time field allowing any given well report to be distinguished from any other well report.

A historical archive 172 includes PVT data for hydrocarbon production system 100 that is not maintained in the defined well report format. Historical archive 172 may include, but is not limited to: PVT data for hydrocarbon production system 100 that is in electronic format, PVT data for hydrocarbon production system 100 that is on paper, PVT data for hydrocarbon production system 100 that is not in a machine processible format, and/or PVT data for hydrocarbon production system 100 that is in a machine processible format.

An archive conversion system 174 includes an input device configured to image paper documents to yield document images in a machine processible format. This machine processible format may be any electronic image format known in the art. Archive conversion system 174 is configured to automatically access PVT data from the document images and to format the data in the defined well report format. Further, archive conversion system 174 is configured to automatically access PVT data that is already in an electronic format in historical archive 172 and to format the data in the defined well report format. The resulting well reports in the defined well report format are stored to current database 170. As with the well reports generated by logging system 160, the date and time field in the defined well report format allows any well report generated by archive conversion system 174 to be distinguished from any other well report in current database 170. In some embodiments, more recent well reports are given greater weight than other well reports in current database.

A well property prediction system 180 is configured to access well reports from current database 170 and to perform one or more analysis of the reports. In some embodiments, well property prediction system 180 is configured to automatically generate a visual representation of a combination of the well reports. In various embodiments, well property prediction system 180 is configured to perform comprehensive analysis of thousands of well reports from current database 170. This comprehensive analysis may include, but is not limited to, PVT property data anomaly detection, PVT sample clustering and comparison, PVT sample classification, and PVT property prediction. As new well reports are stored to current database 170 by logging system 160, the aforementioned comprehensive analysis may be updated automatically upon receipt of the new well report. As such, a combination of logging system 160 and well property prediction system 180 may be configured to generate real-time analysis of hydrocarbon production system 100 based upon a large number of well reports. Based upon the disclosure provided herein, one of ordinary skill in the art will recognize a variety of ways in which well reports of different dates may be used. Having access to significant amount of PVT data in historical archive 172 is helpful increasing the accuracy of the generated well property. This is particularly true where well property prediction system 180 implements a data driven machine learning system to generate the well property.

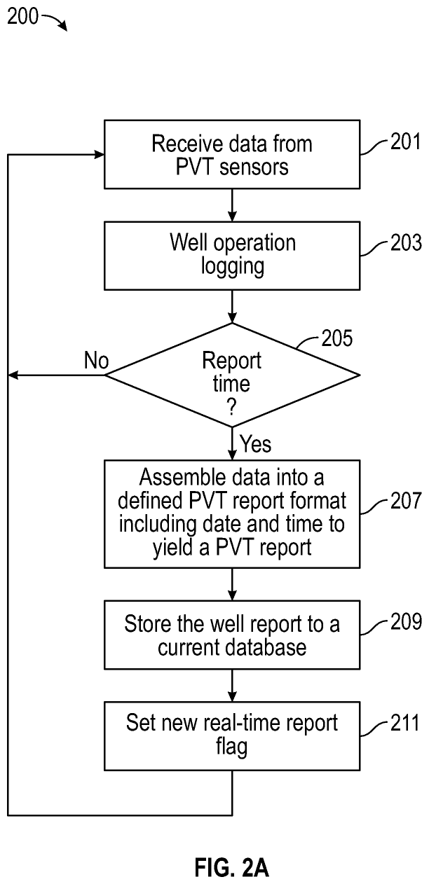

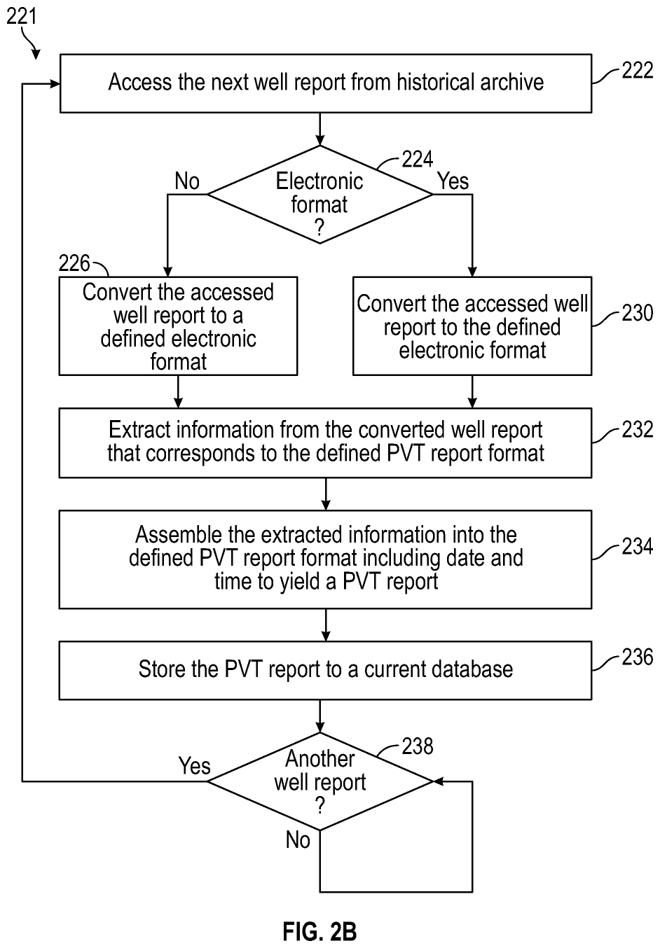

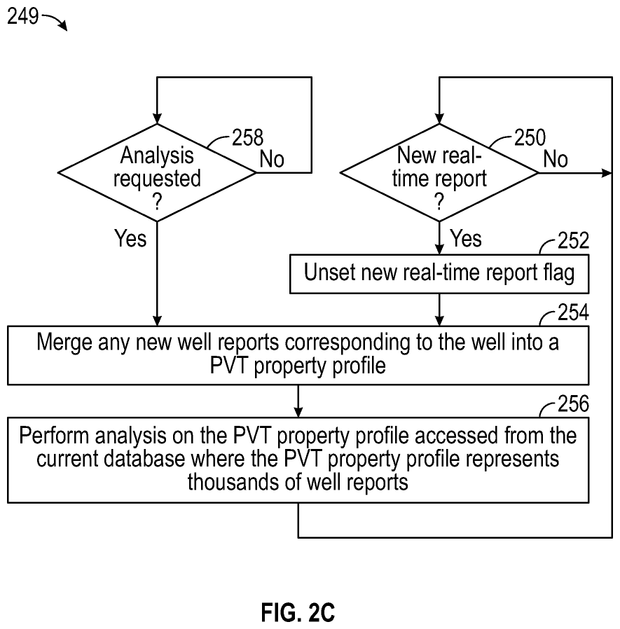

FIGS. 2A-2C are flow diagrams 200, 221, 249 showing a method in accordance with some embodiments for well property generation using pressure, volume, and temperature data derived from multiple sources. Following flow diagram 200 of FIG. 2A, data is received from PVT sensors deployed at one or more locations in a hydrocarbon processing system (block 201). This data may be received, for example, from wellhead sensors 130, isokinetic sampling sensors 135, separator gas sensors 140, separator liquid sensors 145, and/or downhole sampling tool string sensors 150 as discussed above in relation to FIG. 1. The data is stored over time as part of a well logging operation (block 203).

It is determined whether it is time to generate a well report (block 205). In some embodiments, a well report is generated once per day at a defined time. In other embodiments, a well report is generated multiple times per day at defined times. Based upon the disclosure provided herein, one of ordinary skill in the art will recognize a variety of periodic and non-periodic times that may be defined for report generation.

When it is time to generate a well report (block 205), recently measured data received from the PVT sensors is assembled into a defined well report format (block 207). This defined well report format includes a time and date field, and the process includes adding the current time and date with the assembled data to yield a well report. In some embodiments, the defined well report format is an Excel™ spreadsheet, and thus the well report is an Excel™ spreadsheet. Based upon the disclosure provided herein, one of ordinary skill in the art will recognize other defined electronic formats that may be used in relation to different embodiments. This well report is stored to a current database (block 209). The current database is accessible to one or more other processing resources and/or processes, and as more fully discussed below can be used along with thousands of other well reports to generate, among other things, a well property.

A real-time report flag is set (block 211). This real-time report flag is stored in the current database and may be used by one or more other processing resources and/or processes to signal the availability of recently updated data from a well. In some embodiments, as more fully described below, setting this flag causes an update of the PVT property profile for the well and analysis of the updated PVT property profile, and thus generation of the well property in real-time. Accordingly, some embodiments provide an ability to generate a well property based upon thousands of well reports in real-time.

Turning to FIG. 2B and following flow diagram 221, a historical archive is accessed to obtain a next well report for processing (block 222). The historical archive may include well reports that include PVT data. These well reports are not in the defined well report format and in some cases are not even in electronic format that is machine processible. In many applications, it is useful to have a large body of PVT data to increase the accuracy of the generated well property. This is particularly true where the well property is a prediction made by a machine learning system.

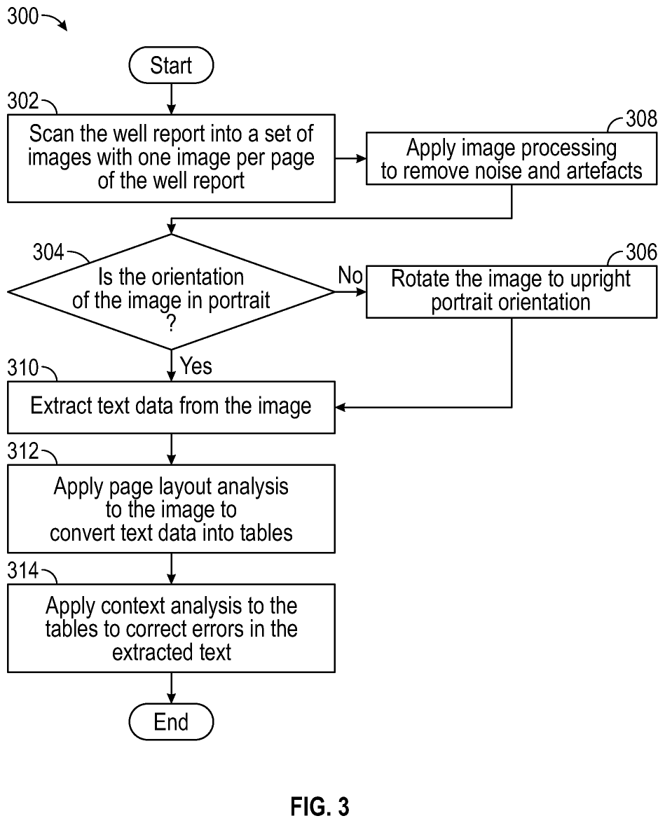

It is determined whether the accessed well report is in an electronic format (block 224). Where the accessed well report is not in electronic format (block 224), it is converted to an interim electronic format (block 226). The conversion to the interim electronic format may be done, for example, using the method discussed below in relation to FIG. 3. Alternatively, where it is determined that the well report is already in an electronic format (block 204), it is converted into the interim electronic format (block 230). This conversion may be done, for example, using the method discussed below in relation to FIG. 4.

Information from the converted well report that corresponds to fields in the defined well report format is extracted from the interim electronic format (block 232). This extracted information is assembled to yield a well report in the defined well report format. A time and date of the well report from the historical archive is included in the well report. As mentioned above, in some embodiments, the defined well report format is an Excel™ spreadsheet, and thus the well report is an Excel™ spreadsheet. Based upon the disclosure provided herein, one of ordinary skill in the art will recognize other defined electronic formats that may be used in relation to different embodiments. This well report is stored to a current database (block 236). The current database is accessible to one or more other processing resources and/or processes, and as more fully discussed below can be used along with thousands of other well reports to generate, among other things, a well property.

It is determined whether there are other well reports in the historical archive that remain to be processed (block 238). Where one or more well reports remain to be processed (block 238), the processes of blocks 222-236 are repeated for the next well report.

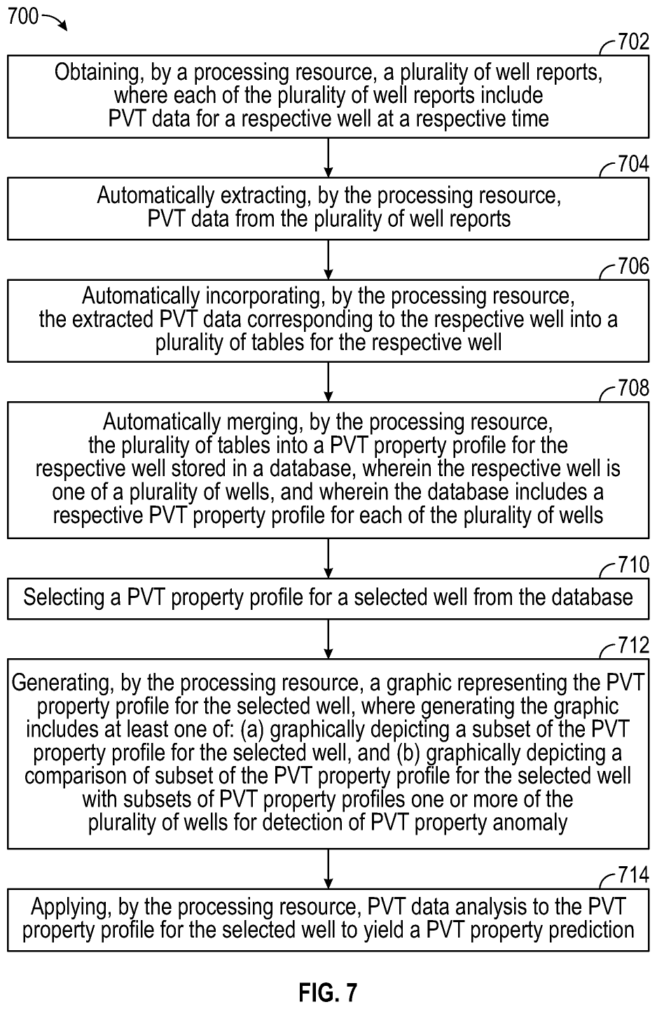

Turning to FIG. 2C and following flow diagram 249, it is determined whether the real-time report flag has been set (block 250). Where it is set (block 250), the real-time report flag is unset in preparation for the next real-time well report being loaded by the logging system into the current database (block 252). Any new well reports corresponding to the well being analyzed are merged into a PVT property profile for the well (block 254). This process results in a combining of data from recently generated well reports into a continuing PVT property profile. As such, a PVT property profile includes an increasing amount of data over time. An analysis of the PVT property profile to the well is accessed from the current database is performed (block 256). For a well that has been in existence for a long time the PVT property profile may represent data gathered from the well which was included in tens, hundreds, thousands, or even tens of thousands of times. Thus, the analysis includes not only a recently received well report, but potentially thousands of well reports that were in part accessed from the historical archive. By performing the analysis upon setting of the real-time report flag, well properties generated by the analysis can be generated in real-time as each well report is received from a logging system. Accordingly, some embodiments provide an ability to generate a well property based upon thousands of well reports in real-time. One embodiment showing an analysis process is discussed below in relation to FIG. 7.

In addition, it is determined whether an analysis has been requested (block 258). An analysis may be requested, for example, by a user operating well property prediction system 180. Upon receiving a request to perform an analysis (block 258), any new well reports corresponding to the well being analyzed are merged into the PVT property profile for the well (block 254). Analysis of the PVT property profile from the current database is performed (block 256). This analysis may include well reports stored to current database 170 by logging system 160 and well reports stored to current database 170 by archive conversion system 174. Again, the well reports stored to current database 170 by archive conversion system 174 may be generated from thousands of well reports maintained in historical archive 172.

Turning to FIG. 3, a flow diagram 300 shows a method for converting a well report accessed from a historical archive to an electronic format in accordance with one or more embodiments. In one or more embodiments, one or more of the blocks shown in FIG. 3 may be omitted, repeated, and/or performed in a different order than the order shown in FIG. 3. Accordingly, the scope of the invention should not be considered limited to the specific arrangement of blocks shown in FIG. 3 Following flow diagram 300, each page of a well report accessed from the historical archive is scanned to yield an image (block 302). Each page of the well report may be converted at a desired resolution based on the quality of the well report. In some embodiment, the resolution is, for example, 96 dpi. In other embodiments, the resolution is 300 dpi or greater to enhance the accuracy of OCR processes. Based upon the disclosure provided herein, one of ordinary skill in the art will recognize a variety of resolutions that may be used in relation to different embodiments.

Image processing is applied to the image in portrait orientation to remove noise and artifacts (block 308). Such image processing may include one or more processes including, but not limited to, erosion and dilation.

It is determined whether the image is in an upright portrait (block 304). If the orientation is determined not to be an upright portrait (e.g., the image is upside down or in landscape orientation) (block 304), the image is rotated to portrait orientation (block 306).

Text data from the image is extracted (block 310). In some embodiments, extraction of the text data is done using OCR. OCR may be achieved using standard tools such as Tesseract. The OCR may produce a data frame which consists of both the text data as well as coordinate information of the text data on a page, in blocks, paragraphs, lines, and sentences. These can be further parsed, following the coordinate information, to produce a structured text file or a spreadsheet. Additionally, OCR may be machine learning based.

Page layout analysis is applied on the image to convert the text boxes extracted from the original document into tables (block 312). Such page layout analysis may be a part of text/data post-processing to replace spurious OCR results such as strange symbols, and incorrectly converted numeric values and letters. Context analysis is applied to the tables to correct any errors that occurred in the extraction process (block 314). The context analysis may include any process known in the art for considering text in its context to identify incongruities which may be errors. As an example, the text may be compared with words around it to determine, when there is some ambiguity, that there are other similar words in the context that were recognized without ambiguity. Based upon the disclosure provided herein, one of ordinary skill in the art will recognize a variety of context analysis that may be used in relation to different embodiments to correct errors.

Using the method described in FIG. 3, an accurate data set is provided for OCR using machine learning. Such machine learning algorithms or models may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters,” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.”

FIG. 4 is a flow diagram 400 showing a method for converting a well report in an electronic format accessed from a historical archive to a defined electronic format in accordance with one or more embodiments. Of note, in some embodiments where the well report is in an electronic format such as, for example, PDF format that already includes text information including the position and the content of each word, there is no need to convert the page into an image as discussed in relation to FIG. 4, but rather the OCR process can be skipped and the table extracted directly from the text information in the electronic document. Flow diagram 400 is substantially the same as flow diagram 300 discussed above in relation to FIG. 3, except that block 402 includes converting the accessed well report into an image. The remaining processes are the same as those discussed in relation to FIG. 3 and result in the extracted text data in the same defined electronic format.

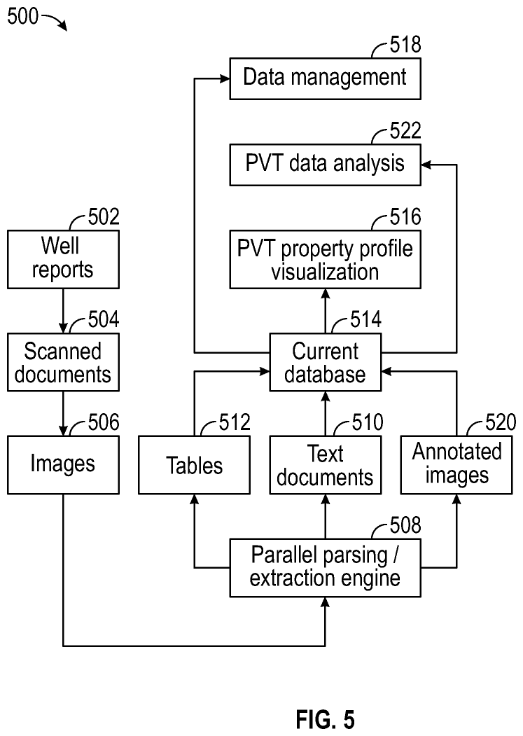

Turning to FIG. 5, a block diagram 500 depicts an example workflow in accordance with some embodiments for performing analysis based at least in part on well reports available in a historical archive in paper form. As shown in block diagram (500) well reports are accessed from a historical archive (502). The well reports include PVT data. The pages of the accessed well reports are scanned (504) to yield one image of each page of the well reports (506).

Parsing and extraction processes are applied to the images by a parsing/extraction engine (508) to yield raw OCR outputs. The raw OCR outputs from the parsing/extraction engine (508) are converted to three different formats: (1) text documents (510) that may be formatted as *.txt files, (2) annotated images (520) that may include recognized text annotated on the images in green boxes, and (3) tables (512) that may be formatted as as *.xls files. All of these three types of files are stored to a current database (514). In some embodiments, a PVT property profile may include a combination of the three types of files for a given well. he stored PVT property profile may be used for individual well PVT property profile visualization (516), PVT data analysis (522), and data management processes (518). Such data management processes may include, but are not limited to, modifying data in the current database (514), deleting data from current database (514), and/or filtering data in the current database (514). As one of many examples, data management may create different subsets of the database for different purposes, including clustering, training inference models, or predicting unknown PVT property profiles.

In one or more embodiments, PVT property profiles (516) may be individual or multiple PVT property profiles. In addition, PVT property profiles (516) may be in a compressed file format such as a ZIP file. Further, scanned documents (504) may be portable document file (PDF). The images (506) may be in, but not limited to, BMP, JPEG, TIFF, GIF.

PVT property profile visualization (516) may provide PVT property data anomaly detection, PVT sample clustering/comparison, PVT sample classification, and/or PVT property prediction. For example, PVT properties of multiple wells may be plotted in multiple curves on the same pressure or temperature range, and be overlayed on top of each other for visual comparison and anomaly identification. In some embodiments, PVT data analysis (522) may be run at times other than after PVT property profile visualization (516). Such analysis may include, but is not limited to, machine learning training and testing. PVT data analysis (522) may provide PVT property data anomaly detection, PVT sample clustering/comparison, PVT sample classification, and/or PVT property prediction. For example, PVT properties of multiple wells may be plotted in multiple curves on the same pressure or temperature range, and be overlayed on top of each other for visual comparison and anomaly identification.

Further, PVT data may be interpolated and extrapolated along pressure and temperature axes within which the PVT properties are measured for unsupervised analysis including PVT sample clustering, and for supervised learning for PVT property prediction on missing data or offset wells, based on data from measured wells. The PVT sample clustering provides a score showing how much clusters are separated. The PVT sample clustering also provides multiples metrics not limited to the R-squire value and the contribution scores of input data.

The PVT property prediction may be used to determine: (1) characterization of specific reservoir/well's fluid behavior under certain conditions, such as bubble point; (2) the differential as well as the flash liberation process where gas is separated from liquid sample; (3) the reservoir/well to surface volume relations; (4) oil/gas formation volume factor—the ratio of oil/gas volume at the reservoir pressure and temperature condition versus those at the surface; and/or (5) the composition of the oil/gas extracted from the reservoir/well.

In one or more embodiments, a user may customize which data from the tables in the current database to use as inputs or outputs for PVT data analysis according to a specific needs.

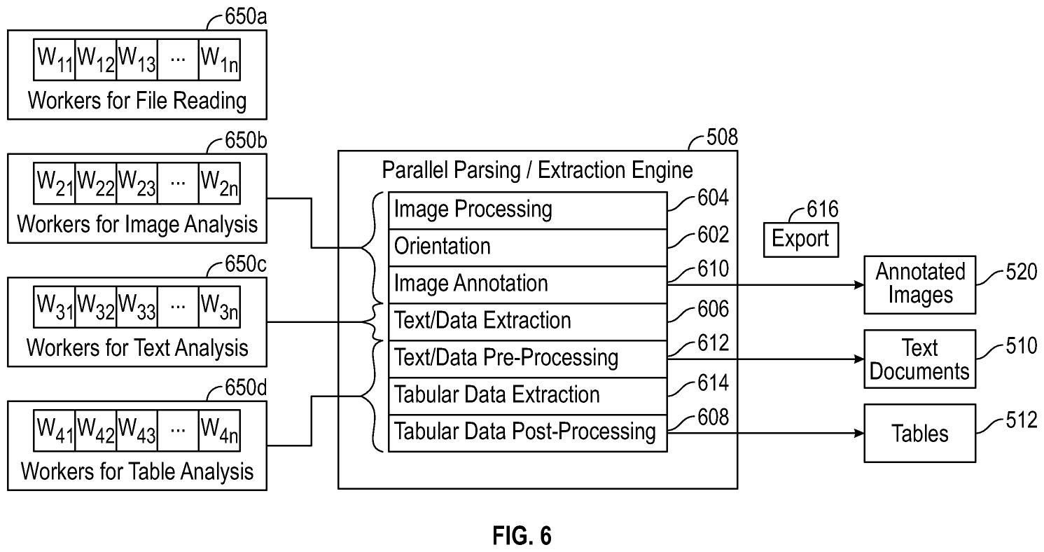

Turning to FIG. 6, a block diagram 600 shows functions of the parsing and extraction engine processes of the workflow of FIG. 5. As shown, parsing/extraction engine (508) includes functions of: orientation (602), image processing (604), image annotation (610), text/data extraction (606), text/data pre-processing (612), tabular data extraction (614). text/data post-processing (608), and export (616).

As mentioned above, some embodiments may incorporate workflow-based parallelism to accelerate the tasks performed as part of the workflow. Such parallelism is shown in FIG. 6 where one or more of orientation (602), image processing (604), image annotation (610), text/data extraction (606), text/data pre-processing (612), tabular data extraction (614). text/data post-processing (608), and/or export (616) are performed in parallel independent of one or more of the other processes. The processes may be deployed in one or both of multithreading and multiprocessing architectures. Various embodiments provide reports which, if workflow-based parallelism is ignored, the processing of such reports may be divided into the following steps:
1. FileRead, used for scheduling the tasks of page parsing.
2. Preprocessing, including image enhancement and annotations.
3. OCR, including the text information extraction. No tabular data is provided in this step.
4. TableExtraction, including the text correction and the tabular data extraction based on the layout analysis.
   An example of such flow was discussed above relation to FIG. 4.

In some embodiments, for each kind of task, several workers 650 (i.e., a worker 650a, a worker 650b, a worker 650c, and/or a worker 650d) are allocated. For example, if multiprocessing is used, there may be ten (10) processes waiting for preprocessing tasks and twenty (20) tasks waiting for optical character recognition (OCR) tasks. In this way, different steps can be run simultaneously. Suppose that the first page of the first report has been preprocessed just now. Then, there should be one worker working on OCR of the same page, while the preprocessing worker will be processing the next page now. As just one of many benefits, embodiments provide for splitting of the computation and I/O. For all tasks, saving the results is always scheduled at the end of the task. Before saving the file, the data processed by the current task will be delivered to another task working for the next step. In this way, the I/O and the computation may be allowed to run simultaneously. This provides balance between the processing and the I/O.

Image processing (604) removes noise and artifacts from an image to make the image clearer. Orientation (602) determines a page orientation of an image, and rotates the page orientation image to portrait mode if the image is not in portrait mode. Image annotation is applied (610) which may include, for example, highlighting all text extracted using OCR with colored boxes.

Text/data extraction (606) provides layout analysis and text/table extraction via machine learning based OCR. For example, OCR may be trained with customized models to process specialized PVT reports. In the text/data extraction (606), texts from an image are extracted via OCR as a raw OCR file. The OCR recognizes the word position, size, and key phrase used in well reports. The resulting text files may be arranged as *.txt files.

Text/data pre-processing (612) is performed which operates to correct any errors (e.g., typographical errors) in the recovered text on a word-by-word basis (i.e., without using context to correct errors). Tablular data extraction (614) is applied to the text are tabulated in a correct table format The table is not necessarily pre-defined. In some embodiments, the table definition is inferred from the position of text (information included with the raw OCR) in the original document image. In some cases, one or more table layouts are detected from the raw OCR file by estimating each table column's horizontal location. Then, the texts are tabulated in a correct table format.

Tabular data post-processing (608) provides filtering and sorting of the extracted tables, and correcting text recognition errors. For example, for each extracted table, the possibility of whether this table belongs to a required table type is evaluated by scoring. If the score is lower than a predetermined threshold, the table will be dropped from the extracted tables. If there are multiple tables belonging to the same type, all the tables will be preserved and sorted in the descending order of their corresponding scores.

Further, if any recognized text via OCR matches one or more errors in a correction rule, the corresponding correction will be automatically applied. In some embodiments, a user may provide a customized configuration file that contains the correction rule. The correction rule may be categorized to: (1) regular expression rules that may allow users to replace some text matching the given regular expressions for removing or correcting wrong punctuation; and (2) fuzzy text matching rules that may allow users to replace phrases with the correct ones if there are any missing, extra, or incorrect characters in whole or a part of the phrase. In one or more embodiments, a user may be allowed manual correction by downloading, modifying, and re-uploading the extracted one or more tables, if any table data is incorrectly recognized and extracted.

Additionally, if recognized data via OCR is incomplete or outliers, the incomplete or outlier data will be removed. In some cases, these low-quality data are preserved in the extracted tables, and a user may be allowed to correct them manually.

In one or more embodiments, the preserved low-quality data may be filtered out during a machine learning process. Additionally, parallel computing techniques may be used to improve computing resource utilization by simultaneously processing different pages of the same or different reports.

Export (610) stores corrected extracted text/data to one or more text documents (510), to one or more tables (512) in table form (e.g., a spreadsheet format), and/or to one or more annotated images (520) (e.g., a PDF format or a JPG format).

Turning to FIG. 7, a flow diagram 700 shows a method for automated well property prediction based upon a plurality of individual well reports in accordance with some embodiments. More specifically, flow diagram 700 includes a method for performing PVT data analysis including training a machine learning model based upon PVT data from wells. In one or more embodiments, one or more of the blocks or steps shown in FIG. 7 may be omitted, repeated, and/or performed in a different order than the order shown in FIG. 7. Accordingly, the scope of the invention should not be considered limited to the specific arrangement of blocks or steps shown in FIG. 7.

Following flow diagram 700, a plurality of well reports are accessed or obtained from a current database (block 702). This may include, for example, accessing a historical archive to access a number of well reports corresponding to a plurality of different wells. In some cases, these well reports may already be in an electronic format and in other cases they are in paper form. Where they are in paper form, the obtaining includes scanning the paper documents to render the well report in electronic form. The plurality of PVT reports may be obtained by a user uploading individual, multiple or zipped PVT reports into a report management system.

PVT data is automatically extracted from the plurality of well reports that were obtained (block 704). The PVT data may be extracted either individually or in batch mode. Embodiments of methods including obtaining well reports and extracting PVT data therefrom are discussed above in relation to FIGS. 3-4

The extracted PVT data is automatically incorporated into a plurality of tables for each of the respective well reports (block 706). In some embodiments, this may include exporting the extracted PVT data to a spreadsheet such as an Excel™ file with each sheet of the Excel™ file capturing a PVT table including PVT data. The original page images, layout annotated page images, and text files for each page of a well report may be exported, and made available for a user to review.

The plurality of tables corresponding to each well are automatically merged into a PVT property profile for each of the respective wells included in a current database (block 708). The current database includes a PVT property profile for each of the wells that is updated each time additional PVT data becomes available for the respective well. In some embodiments, the current database is a relational database management system such as Oracle or other database system.

A PVT property profile for a selected well is selected from the current database (block 710). In some embodiments, the PVT property profile includes a PVT table derived from multiple well reports corresponding to the selected well and accessed from a historical archive, and/or well data from the selected well provided directly from a logging system.

A graphic representing the PVT property profile for the selected well is generated (block 712). Generating the graphic may include, but is not limited to: (a) graphically depicting a subset of the PVT property profile for the selected well, and/or (b) graphically depicting a comparison of subset of the PVT property profile for the selected well with subsets of PVT property profiles one or more of the plurality of wells for detection of PVT property anomaly. The generated graphic may be organized into several tabs on a display. Alternatively or additionally, a user may select to view page layout images.

PVT data analysis is applied on the selected individual well PVT property profile for PVT property prediction (block 714). PVT data analysis may provide PVT property data anomaly detection, PVT sample clustering and comparison, and/or PVT sample classification. PVT data analysis may further provide supervised machine learning for PVT property prediction on missing data or offset wells. In such cases, PVT data in the PVT data profile for a given well or for a number of selected wells may be used to train a PVT data analysis model. In such a case, the trained PVT data analysis model may be applied to PVT data as it is received from a logging system associated with a well. This allows for near real-time access to an updated predicted characteristic of the well. Such an updated predicted characteristic may include, but is not limited to, PVT property data anomaly detection, PVT sample clustering and comparison, and/or PVT sample classification for the well.

Using the method of FIG. 7, an accurate data set is provided for PVT property prediction using machine learning. Such machine learning algorithms or models may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters,” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture.”

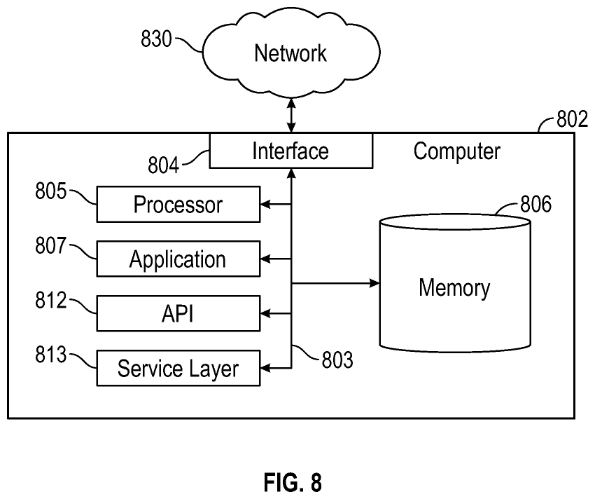

In some embodiments, one or more of logging system 160, well property prediction system 180, and/or archive conversion system 174 may include a computer system. In some embodiments, two or more of logging system 160, well property prediction system 180, and archive conversion system 174 may be implemented using the same computer system. Such a computer system may be similar to that shown in FIG. 8.

Turning to FIG. 8, a block diagram of a computer system used to provide computational functionalities associated with described algorithms, methods, functions, processes, flows, and procedures as described in the instant disclosure, according to an implementation. The illustrated computer 802 in the computer system is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, computer 802 may include a computer that includes an input device, such as a keypad, keyboard, touch screen, or other device that can accept user information, and an output device that conveys information associated with the operation of computer 802, including digital data, visual, or audio information (or a combination of information), or a GUI.

Computer 802 can serve in a role as a client, network component, a server, a database or other persistency, or any other component (or a combination of roles) of a computer system for performing the subject matter described in the instant disclosure. The illustrated computer 802 is communicably coupled with a network 830. In some implementations, one or more components of computer 802 may be configured to operate within environments, including cloud-computing-based, local, global, or other environment (or a combination of environments).

At a high level, computer 802 is an electronic computing device operable to receive, transmit, process, store, or manage data and information associated with the described subject matter. According to some implementations, computer 802 may also include or be communicably coupled with an application server, e-mail server, web server, caching server, streaming data server, business intelligence (BI) server, or other server (or a combination of servers).

Computer 802 can receive requests over network 830 from a client application (for example, executing on another computer 802) and responding to the received requests by processing the said requests in an appropriate software application. In addition, requests may also be sent to computer 802 from internal users (for example, from a command console or by other appropriate access method), external or third-parties, other automated applications, as well as any other appropriate entities, individuals, systems, or computers.

Each of the components of computer 802 can communicate using a system bus (803). In some implementations, any or all of the components of computer 802, both hardware or software (or a combination of hardware and software), may interface with each other or interface 804 (or a combination of both) over the system bus 803 using an application programming interface (API) 812 or a service layer 813 (or a combination of API 812 and service layer 813). API 812 may include specifications for routines, data structures, and object classes. API 812 may be either computer-language independent or dependent and refer to a complete interface, a single function, or even a set of APIs. Service layer 813 provides software services to computer 802 or other components (whether or not illustrated) that are communicably coupled to computer 802. The functionality of computer 802 may be accessible for all service consumers using service layer 813. Software services, such as those provided by service layer 813, provide reusable, defined business functionalities through a defined interface. For example, the interface may be software written in JAVA, C++, Python, or other suitable language providing data in extensible markup language (XML) format or other suitable format. While illustrated as an integrated component of computer 802, alternative implementations may illustrate API 812 or service layer 813 as stand-alone components in relation to other components of computer 802 or other components (whether or not illustrated) that are communicably coupled to computer 802. Moreover, any or all parts of API 812 or service layer 813 may be implemented as child or sub-modules of another software module, enterprise application, or hardware module without departing from the scope of this disclosure.

In one embodiment, the file synchronization priority level and linked policy can be implemented as a software module that is installed on the cloud storage server or a standalone software module that can integrate with cloud storage service via API 812.

Computer 802 includes an interface 804. Although illustrated as a single interface 804 in FIG. 8, two or more interfaces 804 may be used according to particular needs, desires, or particular implementations of computer 802. Interface 804 is used by computer 802 for communicating with other systems in a distributed environment that are connected to network 830. Generally, interface 804 includes logic encoded in software or hardware (or a combination of software and hardware) and operable to communicate with network 830. More specifically, interface 804 may include software supporting one or more communication protocols associated with communications such that network 830 or interface's hardware is operable to communicate physical signals within and outside of the illustrated computer 802.

Computer 802 includes at least one computer processor 805. Although illustrated as a single computer processor 805 in FIG. 8, two or more processors may be used according to particular needs, desires, or particular implementations of computer 802. Generally, computer processor 805 executes instructions and manipulates data to perform the operations of computer 802 and any algorithms, methods, functions, processes, flows, and procedures as described in the instant disclosure.

Computer 802 also includes a memory 806 that holds data for computer 802 or other components (or a combination of both) that can be connected to network 830. For example, memory 806 can be a database storing data consistent with this disclosure. Although illustrated as a single memory 806 in FIG. 5, two or more memories may be used according to particular needs, desires, or particular implementations of computer 802 and the described functionality. While memory 806 is illustrated as an integral component of computer 802, in alternative implementations, memory 806 can be external to computer 802.

The application 807 is an algorithmic software engine providing functionality according to particular needs, desires, or particular implementations of computer 802, particularly with respect to functionality described in this disclosure. For example, application 807 can serve as one or more components, modules, applications, etc. Further, although illustrated as a single application 807, the application 807 may be implemented as multiple applications 807 on computer 802. In addition, although illustrated as integral to computer 802, in alternative implementations, the application 807 can be external to computer 802. In one example, the methods described with reference to FIGS. 2-4 may be implemented by the application 807.

There may be any number of computers 802 associated with, or external to, a computer system containing computer 802, each computer 802 communicating over network (830). Further, the term “client,” “user,” and other appropriate terminology may be used interchangeably as appropriate without departing from the scope of this disclosure. Moreover, this disclosure contemplates that many users may use one computer 802, or that one user may use multiple computers 802. Furthermore, in one or more embodiments, computer 802 is a non-transitory computer readable medium (CRM).

In some embodiments, the computer system 802 is implemented as part of a cloud computing system. For example, a cloud computing system includes one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which are performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AIaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for automated well property prediction based upon a plurality of individual well reports, the method comprising:
obtaining, by a processing resource, a plurality of well reports, wherein each of the plurality of well reports include pressure, volume, and temperature (PVT) data for a respective well at a respective time;
automatically extracting, by the processing resource, PVT data from the plurality of well reports;
automatically incorporating, by the processing resource, the extracted PVT data corresponding to the respective well into a plurality of tables for the respective well;
automatically merging, by the processing resource, the plurality of tables into a PVT property profile for the respective well stored in a database, wherein the respective well is one of a plurality of wells, and wherein the database includes a respective PVT property profile for each of the plurality of wells;
selecting a PVT property profile for a selected well from the database; and
applying, by the processing resource, PVT data analysis to the PVT property profile for the selected well to yield a PVT property prediction.

2. The method according to claim 1, wherein extracting the PVT data comprises:
converting each page of each of the plurality of PVT reports into a set of images;
rotating each image of the set of images to a desired orientation to yield a set of oriented images;
applying image processing to each image of the set of oriented images to remove noise and artifacts and yield a set of processed images;
extracting text data from each image of the set of processed images using optical character recognition (OCR) to yield a text output; and
applying page layout analysis to the text output to correct errors on the extracted text data.

3. The method according to claim 2, wherein the OCR is based on a machine learning.

4. The method according to claim 1, wherein the merging the plurality of tables comprises reassembling the extracted PVT data.

5. The method according to claim 1, wherein the merging the plurality of tables comprises filtering and sorting the extracted PVT data using based at least in part on a score.

6. The method according to claim 1, the method further comprising:
generating, by the processing resource, a graphic representing the PVT property profile for the selected well, wherein generating the graphic comprises at least one of:
graphically depicting a subset of the PVT property profile for the selected well, and graphically depicting a comparison of subset of the PVT property profile for the selected well with subsets of PVT property profiles one or more of the plurality of wells for detection of PVT property anomaly.

7. The method according to claim 1, wherein the applying PVT data analysis comprises interpolation and extrapolation of the extracted PVT data along a pressure and a temperature axis.

8. The method according to claim 1, wherein the PVT property prediction is used to determine at least one of:
characterization of a well's fluid behavior under a bubble point;
a differential and a flash liberation process where gas is separated from liquid sample;
a relationship of the well to a surface volume;
oil and gas formation volume factor; and
a composition of the oil and gas extracted from the well.

9. A system for well property prediction based upon a plurality of individual well reports, the system comprising:
a sensor set configured to sense pressure, volume, and temperature (PVT) data from at least one location at a well site;
a logging system configured to:
receive the PVT data;
merge the PVT data into a PVT property profile stored in a database, wherein the PVT property profile corresponds to a well at the well site, wherein the well is one of a plurality of wells, and wherein the database includes a respective PVT property profile for each of the plurality of wells;
an archive conversion system configured to:
obtain a plurality of well reports for the well, wherein each of the plurality of well reports include PVT data for the well at a respective time;
extract PVT data from the plurality of well reports;
incorporate the extracted PVT data corresponding to the well into a plurality of tables for the well;
merge the plurality of tables into the PVT property profile for the well stored in the database;
a well property prediction system configured to:
select a PVT property profile for a selected well from the database; and
apply PVT data analysis to the PVT property profile for the selected well to yield a PVT property prediction.

10. The system of claim 9, wherein the sensor set comprises: a first sensor set deployed downhole within the well, a second sensor set deployed at a wellhead of the well, and a third sensor set deployed at a separator physically coupled to the wellhead.

11. The system of claim 9, wherein the logging system comprises a processing resource and a computer readable medium coupled to the processing resource, and wherein the computer readable medium includes instructions, which when executed by the processing resource, cause the processing resource to:
receive the PVT data; and
merge the PVT data into the PVT property profile for the well stored in the database.

12. The system of claim 9, wherein the extracting PVT data comprises:
converting each page of each of the plurality of PVT reports into a set of images;
rotating each image of the set of images to a desired orientation to yield a set of oriented images;
applying image processing to each image of the set of oriented images to remove noise and artifacts and yield a set of processed images;
extracting text data from each image of the set of processed images using optical character recognition (OCR) to yield a text output; and
applying page layout analysis to the text output to correct errors on the extracted text data.

13. The system of claim 11, wherein the OCR is based on a machine learning.

14. The system of claim 9, wherein the merging the plurality of tables comprises reassembling the extracted PVT data.

15. The system of claim 9, wherein the merging the plurality of tables comprises filtering and sorting the extracted PVT data using based at least in part on a score.

16. The system of claim 9, wherein the archive conversion system comprises a processing resource and a computer readable medium coupled to the processing resource, and wherein the computer readable medium includes instructions, which when executed by the processing resource, cause the processing resource to:
obtain the plurality of well reports for the well;
extract PVT data from the plurality of well reports;
incorporate the extracted PVT data corresponding to the well into a plurality of tables for the well; and
merge the plurality of tables into the PVT property profile for the well stored in the database.

17. The system of claim 9, wherein the applying PVT data analysis comprises interpolation and extrapolation of the extracted PVT data along a pressure and a temperature axis.

18. The system of claim 9, wherein the PVT property prediction is used to determine at least one of:
characterization of a well's fluid behavior under a bubble point;
a differential and a flash liberation process where gas is separated from liquid sample;
a relationship of the well to a surface volume;
oil and gas formation volume factor; and
a composition of the oil and gas extracted from the well.

19. The system of claim 9, wherein the well property prediction system comprises a processing resource and a computer readable medium coupled to the processing resource, and wherein the computer readable medium includes instructions, which when executed by the processing resource, cause the processing resource to:
select the PVT property profile for the selected well from the database; and
apply PVT data analysis to the PVT property profile for the selected well to yield a PVT property prediction.

20. The system of claim 19, wherein the processing resource is used by both the well property prediction system and the archive conversion system, and wherein the computer readable medium further includes instructions, which when executed by the processing resource, cause the processing resource to:
obtain the plurality of well reports for the well;
extract PVT data from the plurality of well reports;
incorporate the extracted PVT data corresponding to the well into a plurality of tables for the well; and
merge the plurality of tables into the PVT property profile for the well stored in the database.
